(19) United States
(12) Patent Application Publication
(10) Pub. No.: US 2025/0353976 A1
(43) Pub. Date: Nov. 20, 2025

(54) Method for Preparing Polyurethane Microcapsule Shells by Direct Crosslinking of Cellulose and Polyisocyanate

(71) Applicant: Guizhou Power Grid Co., Ltd., Guiyang (CN)

(72) Inventors: Ying ZHANG, Guiyang (CN); Mingwei WANG, Guiyang (CN); Zhe LIU, Guiyang (CN); Pengcheng YU, Guiyang (CN)

(21) Appl. No.: 19/280,185

(22) Filed: Jul. 25, 2025

Related U.S. Application Data
(63) Continuation of application No. PCT/CN2024/105506, filed on Jul. 15, 2024.

(30) Foreign Application Priority Data
Jan. 30, 2024 (CN) 202410128119.0

(51) Int. Cl. C08J 5/02; C08J 3/00

(52) U.S. Cl. CPC C08J 5/02; C08J 3/005

(57) ABSTRACT

The present invention discloses a method for preparing polyurethane microcapsule shells by direct crosslinking of cellulose and polyisocyanate, including: mixing cellulose crystals with deionized water uniformly to obtain an aqueous phase; mixing N,N-dimethylaniline, toluene, and polyisocyanate uniformly to form an oil phase; stirring the oil phase into the aqueous phase for 20 minutes to form an emulsion; and heating and stirring the emulsion, then standing the emulsion for 2 hours, cooling the emulsion to room temperature, and performing filtration, washing, re-filtration, and drying to obtain the polyurethane microcapsule shells. Rigid polyurethane structural shells with high-density carbamate groups are generated. Such direct crosslinking enhances the stability of microcapsules, enabling more reliable product quality.

### CROSS-REFERENCE TO RELATED APPLICATIONS

This application is a continuation of International Application No. PCT/CN2024/105506, filed on Jul. 15, 2024, and claims priority to Chinese Patent Application No. 202410128119.0, filed on Jan. 30, 2024, the entire disclosure of which is incorporated herein by reference.

### TECHNICAL FIELD

The present disclosure belongs to the field of materials science and engineering technology, and specifically relates to a method for preparing polyurethane microcapsule shells by direct crosslinking of cellulose and polyisocyanate.

### BACKGROUND

Microencapsulation is a technology that envelops substances within microcapsules to preserve their stability and properties. The microencapsulation technology was initially applied in the pharmaceutical field to control drug release and improve drug stability. With the continuous development of technology, the microencapsulation technology has gradually been applied in many fields such as food, cosmetics, coatings, rubber, plastics, and ceramics.

A microcapsule is composed of a shell and a core material. According to the properties and shell-forming mechanisms of microcapsules, the structural design methods for microcapsules can be classified into physical and mechanical methods, phase separation methods, and polymerization reaction methods. At present, the commonly used polymerization reaction methods mainly include in-situ polymerization and interfacial polymerization. The in-situ polymerization involves mixing an aqueous solution of polymer monomers with an oil-phase solution of a core monomer to obtain a mixture, stirring an emulsifier into the mixture at a high speed to form an emulsion, and then controlling the reaction between the polymer monomers by changing the temperature or pH value, so that the polymer monomers solidify on the surface of droplets to form shells. However, this method imposes stringent requirements on the polymer monomers for shell formation and demands precisely controlled experimental conditions. These constraints may increase the operational complexity of the preparation process, whereas the interfacial polymerization is simpler.

The interfacial polymerization involves mixing a core material with an oil-phase solution and an aqueous-phase solution of a polymer monomer A to obtain a mixture, stirring an emulsifier into the mixture at a high speed to form an emulsion, adding a reactive monomer B dissolved in an aqueous phase to the stable emulsion, and allowing the two polymer monomers to polymerize at the aqueous-oil interface by means of their highly active molecules to form a shell-encapsulated core material, thereby obtaining microcapsules. The interfacial polymerization is suitable for preparing liquid-encapsulated microcapsules, offering relatively simple methodology and producing microcapsules with excellent compactness. Although the interfacial polymerization can effectively prepare the liquid-encapsulated microcapsules with excellent compactness, the dispersion state during preparation remains a critical factor influencing product performance. For instance, the stirring speed, viscosity, as well as the types and dosages of the emulsifier and the stabilizer all have a significant impact on the particle size distribution and wall thickness of microcapsules. This requires strict control on various parameters during operation, otherwise, product quality may be unstable.

### SUMMARY

The objective of this section is to outline some aspects of the examples of the present disclosure and briefly introduce some preferred examples. Some simplifications or omissions may be made in this section, as well as in the abstract of the specification and the title of the present disclosure, to avoid blurring the objectives of this section, the abstract of the specification, and the title of the present disclosure, and such simplifications or omissions cannot be used for limiting the scope of the present disclosure.

The present disclosure is provided in view of the above problems or the problems in the prior art.

Therefore, an objective of the present disclosure is to overcome the deficiencies in the prior art and provide a method for preparing polyurethane microcapsule shells by direct crosslinking of cellulose and polyisocyanate.

To solve the above technical problems, the present disclosure provides the following technical solution: A method for preparing polyurethane microcapsule shells by direct crosslinking of cellulose and polyisocyanate includes:
mixing cellulose crystals with deionized water uniformly to obtain an aqueous phase;
mixing N,N-dimethylaniline, toluene, and polyisocyanate uniformly to form an oil phase;
stirring the oil phase into the aqueous phase for 20 minutes to form an emulsion; and
heating and stirring the emulsion, then standing the emulsion for 2 hours, cooling the emulsion to room temperature, and performing filtration, washing, re-filtration, and drying to obtain the polyurethane microcapsule shells.

As a preferred solution of the method described in the present disclosure, the polyisocyanate is one of polymethylene polyphenyl isocyanate, toluene diisocyanate, or isophorone diisocyanate.

As a preferred solution of the method described in the present disclosure, a mass ratio of the cellulose crystals to the polyisocyanate is 1.05:8.

As a preferred solution of the method described in the present disclosure, a mass ratio of the N,N-dimethylaniline to the toluene to the polyisocyanate is 3:9:4.

As a preferred solution of the method described in the present disclosure, a volume ratio of the aqueous phase to the oil phase is 4:1.

As a preferred solution of the method described in the present disclosure, a duration of the stirring is 20 minutes, and a rate of the stirring is 1300 r/min.

As a preferred solution of the method described in the present disclosure, the emulsion is heated at 70 to 80 DEG C.

As a preferred solution of the method described in the present disclosure, the rate of the stirring is 200 r/min, and the duration of the stirring is 15 minutes.

Another objective of the present disclosure is to overcome the deficiencies in the prior art and provide a polyurethane microcapsule shell prepared by direct crosslinking of cellulose and polyisocyanate.

Another objective of the present disclosure is to overcome the deficiencies in the prior art and provide a use of the polyurethane microcapsule shell prepared by direct crosslinking of cellulose and polyisocyanate.

The present disclosure achieves the following beneficial effects:

(1) The present disclosure provides a method for preparing polyurethane microcapsule shells by direct crosslinking of nanocrystalline cellulose and polyisocyanate, which generates rigid polyurethane structural shells with high-density carbamate groups. Such direct crosslinking enhances the stability of microcapsules, enabling more reliable product quality.

(2) The amphiphilicity and wettability of cellulose: The crystalline edges of cellulose chains form a “hydrophobic surface”, which facilitates their adsorption at the oil/aqueous interface. This enables cellulose to stabilize emulsion droplets and promote particle repulsion, resulting in dense cellulose accumulation on the droplet surface, which facilitates the formation of uniform and stable microcapsules.

(3) Heating-induced crosslinking reaction: Heating the mixture to 70-80 DEG C can initiate a crosslinking reaction between hydroxyl groups of cellulose and isocyanate groups of polyisocyanate. The heating eliminates steric factors, enhances the reactivity of isocyanate groups, and facilitates polyisocyanate diffusion to reactive sites, thereby promoting the formation of uniform and stable polyurethane microcapsule shells.

### BRIEF DESCRIPTION OF DRAWINGS

To describe the technical solutions in examples of the present disclosure more clearly, the following briefly describes the accompanying drawings required for describing the examples. Apparently, the accompanying drawings in the following descriptions show merely some examples of the present disclosure, and those of ordinary skill in the art can derive other drawings from these drawings without any creative efforts. In the figures:

FIG. 1 is a schematic diagram of a shell-forming reaction for polyurethane microcapsules in the present disclosure.

FIG. 2 is an SEM (Scanning Electron Microscopy) image of a polyurethane microcapsule shell in the present disclosure.

FIG. 3 is a particle size distribution diagram of a polyurethane microcapsule shell prepared in the present disclosure.

### DETAILED DESCRIPTION OF THE EMBODIMENTS

To make the aforementioned objectives, features and advantages of the present disclosure more apparent and comprehensible, the specific examples of the present disclosure are described in detail below with reference to the examples of the specification.

Many specific details are set forth in the following description to facilitate a full understanding of the present disclosure, but the present disclosure can also be implemented in other ways different from those described here, and those skilled in the art can do similar promotions without departing from the connotation of the present disclosure. Therefore, the present disclosure is not limited by the specific examples disclosed below.

Secondly, the term “one example” or “examples” referred to here refers to specific features, structures, or features that may be included in at least one implementation of the present disclosure. The “in one example” appearing in different parts of the present specification does not necessarily refer to the same example, nor a separate or selective example that is mutually exclusive to other examples.

The manufacturers and specifications (purity) of chemical reagents used in the preparation of polyurethane microcapsule shell samples in the method of the present disclosure are shown in Table 1.

TABLE 1

| | Specification or | |
|---|---|---|
| Reagent name | purity | Manufacturer |
| Polymethylene polyphenyl | NCO content | Aladdin Biochemical Technology |
| isocyanate | ~30% | Co., Ltd. |
| Cellulose | Microcrystalline | Aladdin Biochemical Technology |
| | powder, 20 μm | Co., Ltd. |
| Toluene | 99.8% | Aladdin Biochemical Technology |
| | | Co., Ltd. |
| N,N-dimethylaniline | AR | Sinopharm Chemical Reagents |
| | | Co., Ltd. |
| Deionized water | — | Aladdin Biochemical Technology |
| | | Co., Ltd. |

The models and manufacturers of main experimental instruments for preparing polyurethane microcapsule shell samples in the method of the present disclosure are shown in Table 2.

TABLE 2

| Instrument name | Model | Manufacturer |
|---|---|---|
| Thermostatic magnetic stirrer | THC-205 | Langma Technology Co., |
| | | Ltd. |
| Numerically controlled electric stirrer | SCI20-Pro | Beijing Xinyu Technology |
| | | Co., Ltd. |
| Numerically controlled thermostatic | HH-WO-3L | Airide Instruments Co., |
| water bath | | Ltd. |
| Vacuum filter | — | Shanghai Baoling |
| | | Instruments Co., Ltd. |
| Electronic balance | BSA323S | Zhejiang Nade Scientific |
| | | Instruments Co., Ltd. |

### Example 1

This example provides a method for preparing polyurethane (PU) microcapsule shells by direct crosslinking of nanocrystalline cellulose (NCC) and polyisocyanate, including the following steps:

### (1) Preparation of an Aqueous Phase

150 to 200 mL of deionized water was added to a 500 mL beaker, and 1.05 g of cellulose crystals were weighed with an electronic balance and magnetically stirred into the deionized water at 500 r/min for 5 minutes to ensure thorough mixing.

### (2) Preparation of an Emulsion

6 mL of N,N-dimethylaniline (TMA) was mixed with 40 mL of toluene to obtain a mixture, and 8 g of polymethylene polyphenyl isocyanate (PMDI) was stirred into the mixture uniformly to form an oil phase;

The oil phase was poured into the aqueous phase, where a volume ratio of the aqueous phase to the oil phase was 4:1; at room temperature, the oil phase and the aqueous phase were mechanically stirred at 1300 r/min for 20 minutes to form an emulsion.

### (3) Preparation of Microcapsule Shells

The prepared emulsion was stirred in a thermostatic magnetic stirrer at 75 DEG C and 200 r/min for 15 minutes and then stood in a 75 DEG C thermostatic water bath for 2 hours to complete a reaction.

### (4) Washing and Drying

The reaction product was cooled to room temperature, filtered in vacuum, washed with deionized water 5 to 6 times, filtered again, and dried at room temperature for 48 hours to obtain a sample.

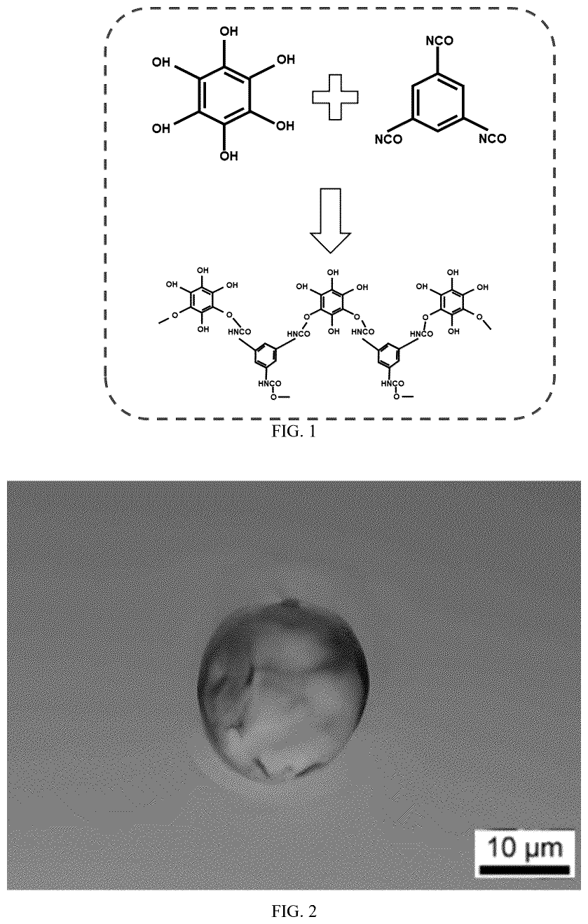

The shell-forming reaction principle of the polyurethane microcapsules in this example was shown in FIG. 1. In a conventional interfacial polycondensation reaction, PU capsule shells were formed based on a moving boundary mechanism, promoting the diffusion of polyol molecules from an aqueous phase to an oil phase to react with an isocyanate. However, in the NCC/PU capsules, PU shells were formed by the diffusion of PMDI.

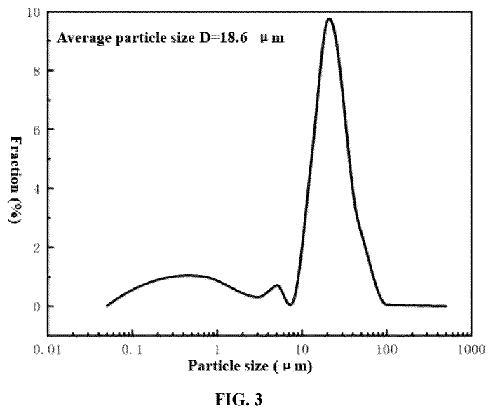

The dried sample was tested and observed by using a scanning electron microscope (SEM), and an SEM image obtained was shown in FIG. 2. It can be seen that the capsules were relatively scattered and did not aggregate, with intact shells. The capsule morphology originated from the initially formed emulsion droplets, which led to their predominant spherical shape. However, some capsules showed an inward bending phenomenon, which may be related to the evaporation of toluene after shell crosslinking. The NCC/PU capsules exhibited smooth and uniform shells, attributed to the dense packing of NCC at the oil/aqueous interface and its further homogeneous crosslinking with PMDI.

The capsule size was calibrated by electron microscopy, and sampling software was employed for statistical analysis. The results demonstrated the formation of non-aggregated capsules with an average size of 18.6 μm, featuring smooth and uniform shells with a thickness of 450 nm. A particle size distribution curve of the capsules was plotted by using Origin plotting software, as shown in FIG. 3. As shown in the figure, the particle size of the prepared sample was concentrated in a range of 10 to 40 μm, with a unimodal size distribution. The relatively small capsule size and concentrated volume distribution indicate the formation of high-quality capsule shells.

### Example 2

This example differs from Example 1 in that the temperature in step (3) was replaced with 70 DEG C, while all other steps remained identical to Example 1. The microcapsules prepared in this example were similar to those in Example 1.

### Example 3

This example differs from Example 1 in that the temperature in step (3) was replaced with 80 DEG C, while all other steps remained identical to Example 1. The microcapsules prepared in this example were similar to those in Example 1.

### Comparative Example 1

This comparative example differs from Example 1 in that the temperature in step (3) was replaced with 50 DEG C, while all other steps remained identical to Example 1. However, due to the insufficient crosslinking reaction caused by excessively low stirring temperature, the capsule formation yield decreased, and the quality of the formed capsules was poor.

### Comparative Example 2

This comparative example differs from Example 1 in that the temperature in step (3) was replaced with 100 DEG C, while all other steps remained identical to Example 1. However, due to the volatilization of some reactants caused by excessively high stirring temperature, capsules were formed with poor quality.

### Comparative Example 3

This comparative example differs from Example 1 in that in step (2), no N,N-dimethylaniline was added, and 8 g of polymethylene polyphenyl isocyanate (PMDI) was stirred into 46 mL of toluene uniformly to form an oil phase, while all other steps remained identical to Example 1. The absence of N,N-dimethylaniline led to insufficient crosslinking, resulting in irregular microcapsule shells.

### Comparative Example 4

This comparative example differs from Example 1 in that N,N-dimethylaniline in step (2) was replaced with 1,3-diethylbenzene, while all other steps remained identical to Example 1. However, the inadequate catalytic activity of 1,3-diethylbenzene led to insufficient crosslinking, resulting in irregular microcapsule shells.

### Comparative Example 5

This comparative example differs from Example 1 in that the volume ratio of the aqueous phase to the oil phase was replaced with 2:1, while all other steps remained identical to Example 1. However, due to the reduced aqueous phase fraction compared to Example 1, insufficient emulsion droplet formation occurred, resulting in larger emulsion droplets with partial coalescence, and yielding capsules with large particle size and poor dispersibility.

### Comparative Example 6

This comparative example differs from Example 1 in that the volume ratio of the aqueous phase to the oil phase was replaced with 6:1, while all other steps remained identical to Example 1. However, due to the excessive aqueous phase fraction, emulsified droplets were formed with poor effect, yielding microcapsules with intact shells.

### Comparative Example 7

This comparative example differs from Example 1 in that the mass ratio of the cellulose crystals to the polyisocyanate was 1:16, while all other steps remained identical to Example 1. However, the insufficient cellulose content led to incomplete surface coverage on emulsion droplets and insufficient crosslinking, resulting in partially intact shell formation and poor quality of microcapsules.

### Comparative Example 8

This comparative example differs from Example 1 in that the mass ratio of the cellulose crystals to the polyisocyanate was 1:4, while all other steps remained identical to Example 1. However, the high cellulose content led to excessively dense surface coverage on emulsion droplets, resulting in rough and excessively thick capsule shells and poor quality of microcapsules.

It should be noted that the above examples are merely used to describe, but not to limit, the technical solutions of the present disclosure. Although the present disclosure is described in detail with reference to the preferred examples, those of ordinary skill in the art should understand that the technical solutions of the present disclosure can be modified or equivalently replaced without departing from the spirit and scope of the technical solutions of the present disclosure, and should fall within the scope of the present disclosure.

What is claimed is:

1. A method for preparing polyurethane microcapsule shells by direct crosslinking of cellulose and polyisocyanate, comprising:
mixing cellulose crystals with deionized water uniformly to obtain an aqueous phase;
mixing N,N-dimethylaniline, toluene, and polyisocyanate uniformly to form an oil phase;
stirring the oil phase into the aqueous phase for 20 minutes to form an emulsion; and
heating and stirring the emulsion, then standing the emulsion for 2 hours, cooling the emulsion to room temperature, and performing filtration, washing, re-filtration, and drying to obtain the polyurethane microcapsule shells.

2. The method according to claim 1, wherein the polyisocyanate is one of polymethylene polyphenyl isocyanate, toluene diisocyanate, or isophorone diisocyanate.

3. The method according to claim 1, wherein a mass ratio of the cellulose crystals to the polyisocyanate is 1.05:8.

4. The method according to claim 1, wherein a mass ratio of the N,N-dimethylaniline to the toluene to the polyisocyanate is 3:9:4.

5. The method according to claim 1, wherein a volume ratio of the aqueous phase to the oil phase is 4:1.

6. The method according to claim 5, wherein a duration of the stirring is 20 minutes, and a rate of the stirring is 1300 r/min.

7. The method according to claim 1, wherein the emulsion is heated at 70 to 80 DEG C.

8. The method according to claim 1, wherein the rate of the stirring is 200 r/min, and the duration of the stirring is 15 minutes.

9. A polyurethane microcapsule shell prepared by the method according to claim 8.

10. A use of the polyurethane microcapsule shell according to claim 9.
